(19) United States
(12) Patent Application Publication
(10) Pub. No.: US 2014/0210951 A1
(43) Pub. Date: Jul. 31, 2014

(54) APPARATUS AND METHOD FOR RECONSTRUCTING THREE-DIMENSIONAL INFORMATION

(71) Applicant: Electronics and Telecommunications Research Institute, Daejeon-city (KR)

(72) Inventor: Seong-Ik CHO, Daejeon (KR)

(73) Assignee: Electronics and Telecommunications Research Institute, Daejeon-city (KR)

(21) Appl. No.: 13/960,525

(22) Filed: Aug. 6, 2013

(30) Foreign Application Priority Data
Jan. 25, 2013 (KR) 10-2013-0008725

(51) Int. Cl. H04N 13/02

(52) U.S. Cl. CPC H04N 13/0203
USPC 348/49

(57) ABSTRACT

Disclosed herein is an apparatus and method for reconstructing 3D information. The present invention calculates a normalized cross correlation value using luminance information included in two or more stereo images, calculates a normalized edge correlation value using local edge information, and extracts disparity surface information from a composite disparity image generated based on two types of matching costs.

### CROSS REFERENCE TO RELATED APPLICATION

This application claims the benefit of Korean Patent Application No. 10-2013-0008725 filed on Jan. 25, 2013, which is hereby incorporated by reference in its entirety into this application.

### BACKGROUND OF THE INVENTION

1. Technical Field

The present invention relates generally to an apparatus and method for reconstructing three-dimensional (3D) information using stereo images and, more particularly, to an apparatus and method for reconstructing 3D information, which calculate a normalized cross correlation value using luminance (brightness) information included in two or more stereo images, calculate a normalized edge correlation value using local edge information, and extract disparity surface information from a composite disparity image generated based on two types of matching costs.

2. Description of the Related Art

The reconstruction of the shape and the motion of a three-dimensional (3D) object, such as a human being, is highly applicable. As a method of reconstructing the information of a 3D object, a stereo matching method can be used. Stereo matching denotes a series of processing procedures for extracting disparity information included in each of two or more images having a parallax and reconstructing the depth information of a target object included in each image. A typical procedure for extracting 3D information from stereo images includes four stages, specifically, the generation of a 3D disparity space image using the results of the calculation of matching costs (matching cost calculation) performed on two-dimensional (2D) stereo images, the aggregation of matching costs included in a predetermined spatial range within the 3D disparity space image (matching cost aggregation), the calculation and optimization of disparity information, and the refining of disparity information. In this case, matching costs are calculated using the luminance values of pixels included in a predetermined region of a 2D stereo image, or using edge or feature information, or using the ranking information of sensors or luminance. The results of calculating matching costs correspond to the value of a single pixel in a 3D disparity space image (see the paper by D. Scharstein and R. Szeliski, 2002, “A taxonomy and evaluation of dense two-frame stereo correspondence algorithms”, International Journal of Computer Vision, Vol. 47, No. 1-3, pp. 7-42).

When a disparity space is configured, the location of a single pixel included in each stereo image corresponds to the location of a single pixel in a disparity space or a generalized disparity space, and so the value of the pixel generated in the disparity space can be obtained using the values of the pixels of stereo images corresponding thereto. In this way, the value of a pixel generated in a disparity space image corresponds to matching costs indicating how similar the corresponding pixels of the stereo images are to each other. The matching costs are calculated using the local distribution of corresponding pixels in the stereo images, and for this calculation, local matching, feature matching, non-parametric transformation, or the like is used.

When local matching is used to calculate matching costs, the distributions of luminance information of a center pixel and its neighboring pixels are used. Typically, a normalized cross correlation, the sum of absolute differences between the corresponding pixels, the sum of squared differences between values, etc. are used.

The range of neighboring pixels participating in the calculation of local matching may be obtained by setting a fixed region, such as a rectangle or a circle, or may be used by defining a variable region such that different participation regions are set for respective center pixels using the local luminance distribution of an input image. In relation to this, the paper by Ke Zhang entitled “Cross-Based Local Stereo Matching Using Orthogonal Integral Images” (IEEE TRANSACTIONS ON CIRCUITS AND SYSTEMS FOR VIDEO TECHNOLOGY, VOL. 19, NO. 7, JULY 2009) discloses a method referred to as a ‘cross-based local support region’ which variably applies a participation region to local matching calculation.

When feature matching is used to calculate matching costs, pieces of feature information, such as edges or gradients included in an image, may be directly compared with each other to generate sparse 3D information, as disclosed in Korean Patent Application Publication No. 2011-0064197 or, alternatively, 3D information may be calculated using the sum of absolute values of differences between a distance from the reference pixel of a left image to an edge in a predetermined direction and a distance from the reference pixel of a right image to an edge in a predetermined direction, as disclosed in Korean Patent No. 0899422.

As a result of calculating matching costs, a disparity space image is configured, and the reconstruction of 3D information using stereo images can be regarded as a procedure for searching a surface having the highest global similarity within the disparity space image. The surface is identical to a single surface having the minimum global cost function value, or a single surface having the maximum global similarity measurement function value. Typically, in order to improve the reliability of the globally optimized 2.5-dimensional surface, the aggregation of matching costs is performed. This procedure may be performed using a method of applying adaptive local weights (see the paper by K. J. Yoon, I. S. Kweon, 2006, entitled “Adaptive Support-Weight Approach for Correspondence Search”, IEEE Trans. Pattern Analysis and Machine Intelligence, Vol. 28, No. 4.), a method using graph-cut (see the paper by V. Kolmogorov and R. Zabih, 2001, entitled “Computing visual correspondence with occlusions using graph cuts”, International Conference on Computer Vision, Vol. 2, pp. 508-515), or a method of aggregating semi-global costs (see the paper by H. Hirschmuller, 2005, entitled “Accurate and efficient stereo processing by semi-global matching and mutual information”, Computer Vision and Pattern Recognition, Vol. 2, pp. 807-814.).

In this way, various stereo matching algorithms for reconstructing 3D information using stereo images have been proposed. Although highly reliable 3D reconstruction may be expected if both the advantages of luminance information and edge information of images are utilized, methods of combining a matching scheme using luminance information with a matching scheme using edge information so that they are afforded equal importance have not yet been presented. Accordingly, there is a problem in that it is difficult to precisely reconstruct 3D information from stereo images using only conventional schemes.

### SUMMARY OF THE INVENTION

Accordingly, the present invention has been made keeping in mind the above problems occurring in the prior art, and an object of the present invention is to provide technology that enables precise 3D information to be reconstructed from a 3D space image by utilizing a local matching scheme using edge information, which is designed to have characteristics identical to those of a local matching scheme using luminance information, in order to solve a problem in that the reliability of disparity information included in a disparity space configured for stereo matching is low, making it difficult to improve the precision of stereo matching.

In accordance with an aspect of the present invention to accomplish the above object, there is provided an apparatus for reconstructing three-dimensional (3D) information, including a stereo image acquisition unit configured to acquire stereo images having a parallax therebetween from an object; an edge information generation unit configured to generate edge information that is feature information about each of the stereo images, using an edge operator; a normalized edge correlation calculation unit configured to calculate a normalized edge correlation coefficient for corresponding pixels in the stereo images by using the edge information; an edge disparity space image generation unit configured to generate a 3D edge disparity space image based on the normalized edge correlation coefficient; and a disparity information extraction unit configured to extract disparity surface information using the edge disparity space image.

Preferably, the edge information generation unit may calculate edge vectors for the corresponding pixels in the stereo images, and then generates the edge information.

Preferably, the normalized edge correlation calculation unit may calculate the normalized edge correlation coefficient using geometric characteristics between the edge vectors calculated for the corresponding pixels in the stereo images.

Preferably, the geometric characteristics between the edge vectors may include an angle between the edge vectors.

Preferably, the apparatus may further include a normalized cross correlation calculation unit configured to calculate a normalized cross correlation coefficient for the corresponding pixels in the stereo images using luminance information of a center pixel and neighboring pixels around the center pixel in each of the stereo images.

Preferably, the apparatus may further include a luminance disparity space image generation unit for generating a 3D luminance disparity space image based on the normalized cross correlation coefficient.

Preferably, the apparatus may further include a disparity space image combination unit configured to combine the edge disparity space image generated by the edge disparity space image generation unit and the luminance disparity space image generated by the luminance disparity space image generation unit into a single composite 3D space image.

Preferably, the disparity information extraction unit may extract the disparity surface information from the composite 3D space image into which the edge disparity space image and the luminance disparity space image are combined.

In accordance with another aspect of the present invention to accomplish the above object, there is provided a method of reconstructing three-dimensional (3D) information, including acquiring, by a stereo image acquisition unit, stereo images having a parallax therebetween from an object; generating, by an edge information generation unit, edge information that is feature information about each of the stereo images, using an edge operator; calculating, by a normalized edge correlation calculation unit, a normalized edge correlation coefficient for corresponding pixels in the stereo images by using the edge information; generating, by an edge disparity space image generation unit, a 3D edge disparity space image based on the normalized edge correlation coefficient; and extracting, by a disparity information extraction unit, disparity surface information from the edge disparity space image.

Preferably, generating the edge information that is the feature information about each of the stereo images may include calculating edge vectors for the corresponding pixels in the stereo images and then generating the edge information.

Preferably, calculating the normalized edge correlation coefficient for the corresponding pixels in the stereo images may include calculating the normalized edge correlation coefficient using geometric characteristics between the edge vectors calculated for the corresponding pixels in the stereo images.

Preferably, the geometric characteristics between the edge vectors may include an angle between the edge vectors.

In accordance with a further aspect of the present invention to accomplish the above object, there is provided a method of reconstructing three-dimensional (3D) information, including acquiring, by a stereo image acquisition unit, stereo images having a parallax therebetween from an object; calculating, by a normalized cross correlation calculation unit, a normalized cross correlation coefficient for the corresponding pixels in the stereo images using luminance information of a center pixel and neighboring pixels around the center pixel in each of the stereo images; generating, by a luminance disparity space image generation unit, a 3D luminance disparity space image based on the normalized cross correlation coefficient calculated for the corresponding pixels in the stereo images; generating, by an edge information generation unit, edge information that is feature information about each of the stereo images, using an edge operator; calculating, by a normalized edge correlation calculation unit, a normalized edge correlation coefficient for the corresponding pixels in the stereo images by using the edge information generated for each of the stereo images; generating, by an edge disparity space image generation unit, a 3D edge disparity space image based on the normalized edge correlation coefficient calculated for the corresponding pixels in the stereo images; combining, by a disparity space image combination unit, the luminance disparity space image generated by the luminance disparity space image generation unit and the edge disparity space image generated by the edge disparity space image generation unit into a single composite 3D space image; and extracting disparity surface information from the composite 3D space image into which the edge disparity space image and the luminance disparity space image are combined.

Preferably, generating the edge information that is the feature information about each of the stereo images may include calculating edge vectors for the corresponding pixels in the stereo images and then generating the edge information.

Preferably, calculating the normalized edge correlation coefficient for the corresponding pixels in the stereo images may include calculating the normalized edge correlation coefficient using geometric characteristics between the edge vectors calculated for the corresponding pixels in the stereo images.

Preferably, the geometric characteristics between the edge vectors calculated for the corresponding pixels in the stereo images may include an angle between the edge vectors calculated for the corresponding pixels in the stereo images.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of an apparatus for reconstructing 3D information according to the present invention;

FIGS. 2A and 2B are diagrams illustrating edge vectors calculated for corresponding pixels in two respective stereo images;

FIG. 3 is a diagram showing a geometric meaning between an edge vector for a corresponding pixel in one stereo image and an edge vector for the corresponding pixel in the other stereo image;

FIG. 4 is a flowchart showing a method of reconstructing 3D information according to an embodiment of the present invention;

FIG. 5 is a flowchart showing a method of reconstructing 3D information according to another embodiment of the present invention; and

FIG. 6 is a graph showing matching errors between a normalized cross correlation and an edge correction.

### DESCRIPTION OF THE PREFERRED EMBODIMENTS

Hereinafter, an apparatus and method for reconstructing three-dimensional (3D) information according to the present invention will be described in detail with reference to the attached drawings. Prior to the detailed description of the present invention, it should be noted that the terms or words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

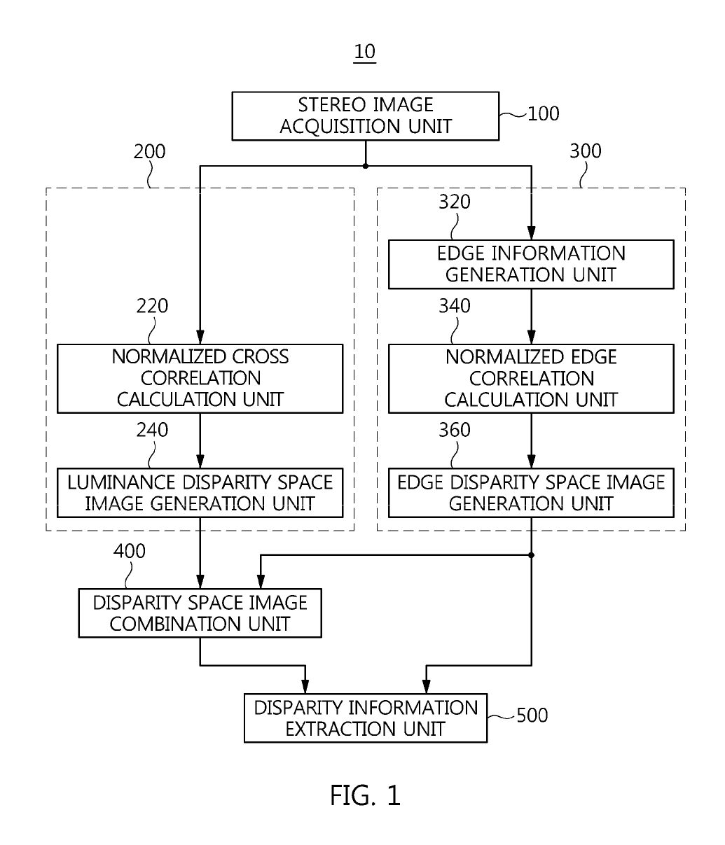

Below, the configuration and operation of an apparatus for reconstructing 3D information according to the present invention will be described with reference to FIGS. 1 to 3.

FIG. 1 is a block diagram showing the configuration of an apparatus for reconstructing 3D information according to the present invention.

Referring to FIG. 1, the 3D information reconstruction apparatus according to the present invention includes a stereo image acquisition unit 100, a luminance disparity space generation unit 200, an edge disparity space generation unit 300, a disparity space image combination unit 400, and a disparity information extraction unit 500. The stereo image acquisition unit 100 obtains two or more stereo images having a parallax between imaging means, such as stereo cameras. The luminance disparity space generation unit 200 generates a luminance disparity space image by calculating the matching costs of normalized cross correlations for all the corresponding pixels within a given searching range of the stereo images. The edge disparity space generation unit 300 generates an edge disparity space image by calculating the matching costs of normalized edge correlations for all the corresponding pixels within a given searching range of the stereo images. The disparity space image combination unit 400 combines the luminance disparity space image and the edge disparity space image into a single composite 3D space image. The disparity information extraction unit 500 extracts disparity surface information from the edge disparity space image generated by the edge disparity space generation unit 300 or extracts disparity surface information from the composite 3D space image output from the disparity space image combination unit 400. In this case, the luminance disparity space generation unit 200 includes a normalized cross correlation calculation unit 220 and a luminance disparity space image generation unit 240. The edge disparity space generation unit 300 includes an edge information generation unit 320, a normalized edge correlation calculation unit 340, and an edge disparity space image generation unit 360.

The stereo image acquisition unit 100 acquires a plurality of images having a parallax therebetween from a specific object using various types of imaging means, such as typical stereo cameras or stereo video cameras. In this case, the stereo image acquisition unit 100 may acquire images having a parallax at the same time point using two or more imaging means, or may acquire images with time differences using a single imaging means and then acquire images in which the motions of a moving object have a parallax.

The normalized cross correlation calculation unit 220 calculates a normalized cross correlation coefficient for corresponding pixels in the stereo images having a parallax therebetween, which are acquired by the stereo image acquisition unit 100, using the luminance information of each center pixel and neighboring pixels around the center pixel in the stereo images. That is, the normalized cross correlation calculation unit 220 uses normalized cross correlations so as to calculate matching costs for corresponding points in two stereo images having a parallax therebetween, acquired by the stereo image acquisition unit 100. In this case, a normalized cross correlation coefficient C_{α}=(x, y, d, w_{α}) calculated by the normalized cross correlation calculation unit 220 using the luminance information of each center pixel and its neighboring pixels for the two stereo images may be represented by the following Equation (1):

$${C}_{α} ( x , y , d , {ω}_{α} ) = \frac{{\sum }_{( u , v ) ∈ {ω}_{α}} ( f - \overline{f} ) ( g - \overline{g} )}{{\sum }_{( u , v ) ∈ {ω}_{α}} {( f - \overline{f} )}^{2} {\sum }_{( u , v ) ∈ {ω}_{α}} {( g - \overline{g} )}^{2}} \qquad ( 1 )$$

where f and g respectively denote the luminance value of a specific center pixel and the luminance values of its neighboring pixels in one of the two stereo images (hereinafter referred to as ‘F’) and in the other stereo image (hereinafter referred to as ‘G’). If it is assumed that the location coordinates of the center pixel in any one of the two stereo images are (x, y), and an expected disparity value is d, f and g can be represented by f=f(x+u, y+v) and g=g(x−d+u, y+v), respectively. Further, w_{α} denotes a set of neighboring pixels around the center pixel, and has a pixel located at (u, v) around the location coordinates of the center pixel as an element. Further, the mean value of luminance values of f(w_{α}) which are pixels included in the range of w_{α}in the stereo image F can be represented by f̅=f(x, y) and the mean value of luminance values of g(d, w_{α}) which are pixels included in the range of w_{α} in the stereo image G can be represented by g̅=g(x−d, y).

Meanwhile, the normalized cross correlation coefficient is also referred to as a Pearson's correlation coefficient, and the geometric meaning thereof denotes an angle between two linear regression lines when f(w_{α}) and g(d, w_{α}) which are pixels included in the range of w_{α} in the two stereo images F and G are represented by two-dimensional (2D) scattergram. That is, in a case where a linear regression line obtained by projecting f(w_{α}) onto g(d, w_{α}) is f_{g}(w_{α}) and a linear regression line obtained by projecting g(d, w_{α}) onto f(w_{α}) is g_{f}(d, w_{α}) , the Pearson's correlation coefficient can be represented by C_{α}(x, y, d, w_{α})=cos θ_{w}_{_{α}}=f_{g}(w_{α})·g_{f}(d, w_{α}), where θ_{w}_{_{α}} denotes an angle between two linear regression lines, and the Pearson's correlation coefficient denotes an inner product of the vectors of the two linear regression lines. In this case, the normalized cross correlation coefficient has a value between −1.0 and +1.0. A case where the normalized cross correlation coefficient is +1.0 means that two data sets f(w_{α}) and g(d, w_{α}) have a completely identical luminance distribution in 2D scattergram.

The luminance disparity space image generation unit 240 generates a 3D luminance disparity space image based on the normalized cross correlation coefficient for corresponding pixels in the stereo images, calculated by the normalized cross correlation calculation unit 220. That is, the luminance disparity space image generation unit 240 generates a 3D disparity space image using matching costs (normalized cross correlation coefficients) for all the corresponding pixels within a given searching range of the stereo images, calculated by the normalized cross correlation calculation unit 220. In greater detail, as the normalized cross correlation coefficient C_{α}(x, y, d, w_{α}) indicating matching cost is calculated, by the normalized cross correlation calculation unit 220, for f(x, y) and g(x−d, y) which are the corresponding pixels included in the two stereo images F and G, matching costs for all disparity locations d are calculated for respective pixel locations (x, y) of the 2D stereo images. Accordingly, the luminance disparity space image generation unit 240 generates a luminance disparity space image defined by three-dimensional coordinates (x, y, d).

The edge information generation unit 320 generates edge information, which is the feature information about each of the stereo images acquired by the stereo image acquisition unit 100, using an edge operator. In this case, the edge information generation unit 320 may extract edge information from each of the two stereo images F and G by utilizing an edge operator, such as a Sobel operator or a Prewitt operator, or by fitting the local luminance distribution of each image to a plane.

In greater detail, when the edge information generation unit 320 extracts edge information from each of the two stereo images F and G using a Sobel operator, the edge information generation unit 320 can calculate edge vectors using a widely known 3×3 Sobel operator, as represented by the following Equations (2) and (3):

$$\begin{matrix}{D}_{h} ( f ( x , y , {w}_{δ} = 3 ) ) = [ \begin{matrix}- 1 & 0 & 1 \\ - 2 & 0 & 2 \\ - 1 & 0 & 1\end{matrix} ] * f ( x , y ) & ( 2 ) \\ {D}_{v} ( f ( x , y , {w}_{δ} = 3 ) ) = [ \begin{matrix}- 1 & - 2 & - 1 \\ 0 & 0 & 0 \\ 1 & 2 & 1\end{matrix} ] * f ( x , y ) & ( 3 )\end{matrix}$$

where Dₕ(f(x, y, w_{δ}=3)) denotes the magnitude of a horizontal edge vector, which is calculated using a 3×3 operator for w_{δ}=3 at a pixel point f(x, y) located at the coordinates (x, y) in the stereo image F. Further, Dᵥ(f(x, y, w_{δ}=3)) denotes the magnitude of a vertical edge vector, which is calculated using a 3×3 operator for w_{δ}=3 at a pixel point f(x, y) located at the coordinates (x, y) in the stereo image F. Furthermore, * denotes that a Sobel kernel represented in the form of a matrix is applied to f(x, y), and w_{δ} denotes the range of neighboring pixels (that is, weight represented by the size of a kernel) used to calculate edge information.

Meanwhile, since the 3×3 Sobel kernel can be resolved, as given by the following Equation (4), the Sobel kernel can be extended to, not only the 3×3 Sobel kernel for w_{δ}=3, but also a Sobel kernel having other size, using these characteristics.

$$[ \begin{matrix}- 1 & 0 & 1 \\ - 2 & 0 & 2 \\ - 1 & 0 & 1\end{matrix} ] = [ \begin{matrix}1 \\ 2 \\ 1\end{matrix} ] [ - 1 - 2 - 1 ] \qquad ( 4 )$$

For example, a 5×5 Sobel kernel for w_{δ}=5 can be represented by the following Equation (5), and a 7×7 Sobel kernel for w_{δ}=7 can be represented by the following Equation (6):

$$\begin{matrix} [ \begin{matrix}1 \\ 4 \\ 6 \\ 4 \\ 1\end{matrix} ] [ \begin{matrix}- 1 & - 2 & 0 & 2 & 1\end{matrix} ] = [ \begin{matrix}- 1 & - 2 & 0 & 2 & 1 \\ - 4 & - 8 & 0 & 8 & 4 \\ - 6 & - 12 & 0 & 12 & 6 \\ - 4 & - 8 & 0 & 8 & 4 \\ - 1 & - 2 & 0 & 2 & 1\end{matrix} ] & ( 5 ) \\ [ \begin{matrix}1 \\ 6 \\ 15 \\ 20 \\ 15 \\ 6 \\ 1\end{matrix} ] [ \begin{matrix}- 1 & - 2 & - 3 & 0 & 3 & 2 & 1\end{matrix} ] = [ \begin{matrix}- 1 & - 2 & - 3 & 0 & 3 & 2 & 1 \\ - 6 & - 12 & - 18 & 0 & 18 & 12 & 6 \\ - 15 & - 30 & - 45 & 0 & 45 & 30 & 15 \\ - 20 & - 40 & - 60 & 0 & 60 & 40 & 20 \\ - 15 & - 30 & - 45 & 0 & 45 & 30 & 15 \\ - 6 & - 12 & - 18 & 0 & 18 & 12 & 6 \\ - 1 & - 2 & - 3 & 0 & 3 & 2 & 1\end{matrix} ] & ( 6 )\end{matrix}$$

In this case, column vectors represented in left terms in Equations (5) and (6) are represented by binomial coefficients.

Further, in order to calculate the edge vectors, the edge information generation unit 320 may use a 5×5 Sobel kernel represented by the following Equation (7) for w_{δ}=5, and a 7×7 Sobel kernel represented by the following Equation (8) for w_{δ}=7, as other types of Sobel kernels having relatively low weighting factors.

$$\begin{matrix} [ \begin{matrix}1 \\ 2 \\ 3 \\ 2 \\ 1\end{matrix} ] [ \begin{matrix}1 & - 2 & 0 & 2 & 1\end{matrix} ] = [ \begin{matrix}- 1 & - 2 & 0 & 2 & 1 \\ - 2 & - 4 & 0 & 4 & 2 \\ - 3 & - 6 & 0 & 6 & 3 \\ - 2 & - 4 & 0 & 4 & 2 \\ - 1 & - 2 & 0 & 2 & 1\end{matrix} ] & ( 7 ) \\ [ \begin{matrix}1 \\ 2 \\ 3 \\ 4 \\ 3 \\ 2 \\ 1\end{matrix} ] [ \begin{matrix}- 1 & - 2 & - 3 & 0 & 3 & 2 & 1\end{matrix} ] = [ \begin{matrix}- 1 & - 2 & - 3 & 0 & 3 & 2 & 1 \\ - 2 & - 4 & - 6 & 0 & 6 & 4 & 2 \\ - 3 & - 6 & - 9 & 0 & 9 & 6 & 3 \\ - 4 & - 8 & - 12 & 0 & 12 & 8 & 4 \\ - 3 & - 6 & - 9 & 0 & 9 & 6 & 3 \\ - 2 & - 4 & - 6 & 0 & 6 & 4 & 2 \\ - 1 & - 2 & - 3 & 0 & 3 & 2 & 1\end{matrix} ] & ( 8 )\end{matrix}$$

Meanwhile, when the edge information generation unit 320 extracts edge information from each of two stereo images F and G using a Prewitt operator, the calculation of edge vectors by the edge information generation unit 320 may be performed by substituting 1 for a positive value and −1 for a negative value in the kernel of the Sobel operator.

When the edge information generation unit 320 extracts edge information from each of the two stereo images F and G by fitting the local luminance distributions of the images to a plane, the edge information generation unit 320 may calculate the magnitudes of horizontal and vertical edge vectors by fitting the local luminance distributions of the two stereo images F and G to the plane. When an equation for the plane to which the local luminance distributions are fitted is assumed to be z=Au+By+z₀, u and v denote the coordinate values of the location coordinates (u, v) of each pixel belonging to a participation region w_{δ}, for participation in the calculation of the magnitudes of the edge vectors, around the center pixel (x, y), and z denotes the luminance value of the pixel based on the local location coordinates of the fitted plane. Here, A, B and z₀ denote the parameters of a locally fitted plane. In this case, the equation of the plane reflecting a local luminance distribution can be calculated using a well-known method, such as least square fitting, orthogonal regression fitting, or RANdom SAmple Consensus (RANSAC) fitting. When the equation of the plane fitted using the participation region w_{δ} for participation in the calculation of the magnitudes of the edge vectors around a single center pixel f(x, y) in an image is z_{f}=A_{f}u+B_{f}v+z₀, the magnitudes of a horizontal edge vector and a vertical edge vector are Dₕ(f(x, y, w_{δ})=A_{f} and Dᵥ(f(x, y, w_{δ}))=B_{f}, respectively. In this case, while the edge information generation unit 320 obtains the magnitudes of the edge vectors using a plane fitting method, there is no need to fix the participation region, in which participation in the calculation of the edge vectors is to be performed, as a rectangular shape. For example, as presented in the paper by Ke Zhang, entitled “Cross-Based Local Stereo Matching Using Orthogonal” (IEEE TRANSACTIONS ON CIRCUITS AND SYSTEMS FOR VIDEO TECHNOLOGY, VOL. 19, NO. 7, JULY 2009), a participation region may be defined as a region variously changing according to each center pixel. And then plane fitting is performed using the local luminance distribution of pixels included in the participation region, and the magnitudes of edge vectors can be calculated using the results of the plane fitting.

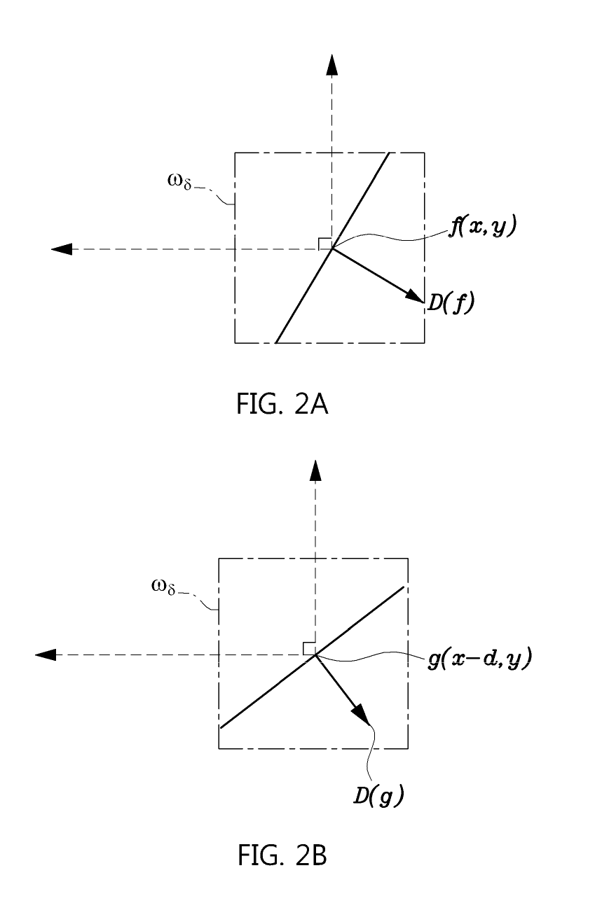

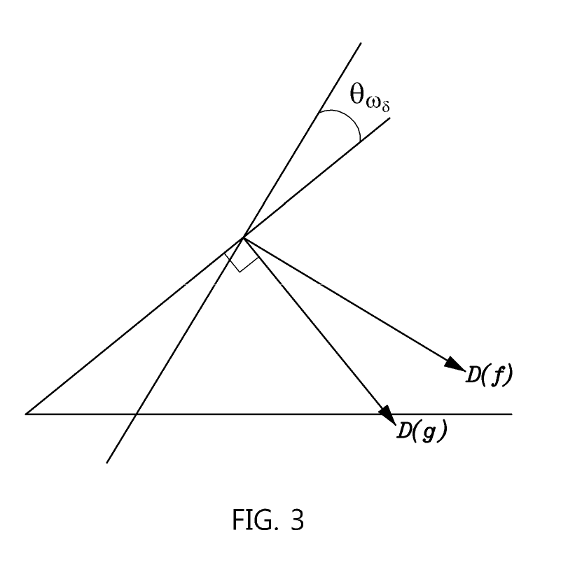

The normalized edge correlation calculation unit 340 calculates a normalized edge correlation coefficient for the corresponding pixels in the stereo images using pieces of edge information generated for the respective stereo images by the edge information generation unit 320. That is, the normalized edge correlation calculation unit 340 calculates a matching cost having the same characteristics as the normalized cross correlation using the geometric characteristics of the horizontal and vertical edge vectors calculated by the edge information generation unit 320. Exemplarily, when an edge vector calculated for the corresponding pixel f(x, y) of the stereo image F is represented by FIG. 2A, and an edge vector calculated for the corresponding pixel g(x−d, y) of the stereo image G is represented by FIG. 2B, a geometric meaning between the edge vectors for the corresponding pixel of the stereo image F and the corresponding pixel of the stereo image G can be illustrated, as shown in FIG. 3. Referring to FIGS. 2A and 2B, an edge vector calculated using the luminance information of the center pixel f(x, y) and the neighboring pixels w_{δ} in the stereo image F is D(f), and an edge vector calculated using the luminance information of the center pixel g(x−d, y) and neighboring pixels w_{δ} in the stereo image G is D(g). In the stereo images F and G, f(x, y) and g(x−d, y) form a pair of corresponding pixels, and thus the matching cost based on the pieces of edge information of the stereo images F and G at the corresponding location can be represented by O is an angle between the edge vectors D(f) and D(g), as shown in FIG. 3.

When the directions of the edge vectors D(f) and D(g) are identical to each other, that is when θ_{w}_{_{δ}}=0°, it can be analyzed that the luminance characteristics of the stereo images F and G, which are represented by the corresponding pixels f(x, y) and g(x−d, y) and their neighboring pixels in the stereo images, are identical to each other. In contrast, when the directions of the edge vectors D(f) and D(g) are greatly different from each other, that is when θ_{w}_{δ}=90°, it can be analyzed that there is little similarity between the luminance characteristics of the stereo images F and G. Further, when the directions of the edge vectors D(f) and D(g) are directly opposite to each other, that is when θ_{w}_{δ}=180°, it can be analyzed that the luminance distributions of the stereo images F and G have characteristics opposite to each other. Therefore, the normalized edge correlation can be defined in the manner similar to that of the Pearson's correlation coefficient. For this, a normalized vertical edge vector and a normalized horizontal edge vector are defined. First, the total magnitude D(f(x, y, w_{δ})) of the edge vectors for a single pixel f(x, y) can be defined by the following Equation (9) using the magnitudes of the horizontal edge vector and the vertical edge vector.

$$D ( f ( x , y , {w}_{δ} ) ) = \sqrt{{{D}_{h} ( f ( x , y , {w}_{δ} ) )}^{2} + {{D}_{v} ( f ( x , y , {w}_{δ} ) )}^{2}} \qquad ( 9 )$$

Further, a normalized horizontal edge vector Eₕ(f(x, y, w_{δ})) is defined by the following Equation (10), and a normalized vertical edge vector Eᵥ(f(x, y, w_{δ})) is defined by the following Equation (11):

$$\begin{matrix}{E}_{h} ( f ( x , y , {w}_{δ} ) ) = \frac{{D}_{h} ( f ( x , y , {w}_{δ} ) )}{D ( f ( x , y , {w}_{δ} ) )} = \frac{{D}_{h} ( f ( x , y , {w}_{δ} ) )}{{{D}_{h} ( f ( x , y , {w}_{δ} ) )}^{2} + {{D}_{v} ( f ( x , y , {w}_{δ} ) )}^{2}} & ( 10 ) \\ {E}_{v} ( f ( x , y , {w}_{δ} ) ) = \frac{{D}_{v} ( f ( x , y , {w}_{δ} ) )}{D ( f ( x , y , {w}_{δ} ) )} = \frac{{D}_{v} ( f ( x , y , {w}_{δ} ) )}{{{D}_{h} ( f ( x , y , {w}_{δ} ) )}^{2} + {{D}_{v} ( f ( x , y , {w}_{δ} ) )}^{2}} & ( 11 )\end{matrix}$$

Finally, the normalized edge correlation coefficient C_{β} is defined by the following Equation (12):

C_{β}(x, y, d, w_{δ}, w_{β})=Σ_{(x, y)∈w}_{_{δ}} cos(θ_{w}_{_{δ}}(x+u, y+v)) (12)

where θ_{w}_{_{δ}}(x+u, y+v) denotes the cosine of an angle between the stereo edge vectors calculated using neighboring pixels included in the range of w_{δ} at the location (x+u, y+v), and w_{β} denotes a range in which pieces of information about the neighboring pixels are collected and combined. That is, w_{β} obtained during the procedure for calculating the normalized edge correlation coefficient has a meaning corresponding to w_{α} obtained during the procedure for calculating the normalized cross correlation coefficient.

Since a cosine value in normalized edge correlation refers to an inner product of two vectors, C_{β} can be represented by the following Equation (13):

C_{β}(x, y, d, w_{δ}, w_{β})=Σ_{(x, y)∈w}_{_{δ}}(Eₕ(f(Eₕ(g)+Eᵥ(f)Eᵥ(g)) (13)

where Eₕ(f)=Eₕ(f(x, y, w_{δ})), Eₕ(g)=Eₕ(g(x−d, y, w_{δ})), Eᵥ(f)=Eᵥ(f(x, y, w_{δ})), and Eᵥ(g)=Eᵥ(g(x−d, y, w_{δ})). Similar to the normalized cross correlation coefficient, the normalized edge correlation coefficient C_{β} has a value between −1.0 and +1.0. C_{β} being +1.0 means that two data sets f(w_{δ}, w_{β}) and g(d, w_{δ}, w_{β}) have completely identical edge information in the 2D scattergram.

The edge disparity space image generation unit 360 generates a 3D edge disparity space image based on the normalized edge correlation coefficient calculated for the corresponding pixels in the stereo images. That is, the edge disparity space image generation unit 360 generates a 3D disparity space image using matching costs for all corresponding pixels calculated by the normalized edge correlation calculation unit 340. In greater detail, as matching cost C_{β}(x, y, d, w_{δ}, w_{β}) based on edges for the corresponding pixels f(x, y) and g(x−d, y) included in the stereo images F and G is calculated by the normalized edge correlation calculation unit 340, matching costs for all disparity locations d are calculated for respective pixel locations (x, y) of the 2D stereo images. Thus, the edge disparity space image generation unit 360 generates an edge disparity space image defined by 3D coordinates (x, y, d). Generally, during the procedure for calculating the normalized cross correlation coefficient C_{α}(x, y, d, w_{α}), the range w_{α} of the neighboring pixels is fixed to and used in a predetermined size for all of the stereo images. The range w_{β} of the neighboring pixels used to calculate the normalized edge correlation coefficient C_{β}(x, y, d, w_{δ}, w_{β}) may also have the same range as w_{α} , or may be fixed to a predetermine size for all of the stereo images. However, the range of neighboring pixels is not necessarily fixed to the same range for all of the stereo images. Since the total magnitude of edge vectors D(f(x, y, w_{δ})) reflects information indicating how rapidly the luminance distributions of one center pixel (x, y) and its neighboring pixels in each stereo image are changing, the ranges of w_{α} and w_{β} may be variably designated using such information. That is, in a region in which a change in the luminance of the neighboring pixels is large, the ranges of w_{α} and w_{β} can be designated as relatively narrow ranges, whereas in a region in which a change in the luminance of the neighboring pixels is small, the ranges of w_{α} and w_{β} can be designated as relatively wide ranges. In this way, a variable window size (that is, the variable range of w_{α} and w_{β}) can be designated by using the following Equation (14):

w_{α}=S−T ln(1+D_{%}) (14)

where S and T denote predefined constants, ln( ) denotes a natural logarithm, and D_{%} denotes the total magnitude of the edge vectors expressed as a percentage. The reason for adding 1 to D_{%} which is the percentage of the total magnitude of the edge vectors is that the value of the natural logarithm is not defined at a value of 0. In this case, the percentage D_{%} of the total magnitude of the edge vectors is defined by the following Equation (15):

$${D}_{\%} = 100 * \frac{D ( f ( x , y , {w}_{δ} ) )}{K ( {w}_{δ} )} \qquad ( 15 )$$

where D(f(x, y, w_{δ})) denotes the total magnitude of edge vectors for the center pixel (x, y), K(w_{δ}) denotes a value obtained by multiplying the maximum luminance value of the image by the weighting factor of the entire edge kernel. When w_{δ}=5 in the edge kernel, K(w_{δ}) is defined as a value obtained by multiplying the maximum luminance value of the image by the value 27(=2+4+6+8+2+1+2+3+2+1) which is the sum of weighting factors of the entire kernel. For example, when one pixel of the stereo image has luminance information of 8 bits, the maximum luminance value of the image is 255, and then K(w_{δ}=5)=27*255 is obtained. S and T are predefined constants, wherein S denotes the size of a maximum window allocable to a region having little texture in the stereo image at D_{%}=0, and T denotes the size of a minimum window allocable to a region having the largest change in luminance at D_{%}=100. It is preferable to use the same S and T for w_{α} and w_{β}, but S and T having the same value are not necessarily used.

The disparity space image combination unit 400 combines the luminance disparity space image generated by the luminance disparity space image generation unit 240 and the edge disparity space image generated by the edge disparity space image generation unit 360 into a single composite 3D space image. That is, the disparity space image combination unit 400 combines the 3D luminance disparity space image, generated by the luminance disparity space image generation unit 240 according to a normalized correlation matching scheme that uses the luminance information of images, and a 3D edge disparity space image, generated by the edge disparity space image generation unit 360 according to a normalized edge matching scheme that uses the feature information of images, into a single composite 3D space image. Whether the combination of two types of 3D disparity space images is logically possible can be analyzed based on the geometric meaning of the normalized cross correlation coefficient and the normalized edge correlation coefficient. In this case, the Pearson's correlation coefficient which is the normalized cross correlation coefficient has a geometric meaning corresponding to an angle between lines based on linear regression equations obtained by projecting the space and luminance characteristics of one stereo image onto another stereo image, and the geometric meaning of the normalized edge correlation coefficient can be analyzed by comparing the normalized edge correction coefficient with the Pearson's correlation coefficient. The edge vector calculated in normalized edge correlation means the results of calculation of information capable of representing the luminance distributions of one center pixel and neighboring pixel locations using the space and luminance characteristics of one stereo image. That is, the edge vector calculated in normalized edge correlation is a vector calculated in a state in which the space and luminance characteristics of another stereo image are not taken into consideration. Normalized edge correlation has a concept different from that of a regression equation in the Pearson's correlation coefficient in that the space and luminance characteristics of one stereo image are not projected onto another stereo image or in that a linear correlation is not obtained. However, those two types of correlation coefficients have similar characteristics in that a vector representing the space and luminance characteristics of one stereo image is obtained and an inner product of the obtained vector and the vector of another stereo image is obtained. The normalized cross correlation and the normalized edge correlation have identical geometric structure and characteristics in that an inner product of stereo vectors indicating the luminance distributions of images is calculated. The range of each of the normalized cross correlation coefficient and the normalized edge correlation coefficient is limited to a range between −1.0 and +1.0, and thus it is possible to combine the edge disparity space image with the luminance disparity space image.

Meanwhile, when the value of one pixel of the luminance disparity space image is C_{α}(x, y, d), and the value of the pixel of the edge disparity space image at the same location is C_{β}(x, y, d), the value of the pixel C(x, y, d) of the final composite disparity space image is defined by the following Equation (16):

C(x, y, d)=(1−γ)C_{α}(x, y, d)+γC_{β}(x, y, d) (16)

where γ may be fixed so that it has the same value throughout the entire image, or may be changed so that it has different values depending on the luminance distribution characteristics of respective pixels. When γ is changed to have different values at respective pixels, the value of γ can be defined by the following Equation (17) using D_{%} expressing the total magnitude of the edge vectors as a percentage.

γ=m+(1−2m)D_{%} (17)

where m denotes an allowable minimum value of γ. For example, when m=0.3, γ has a value from 0.3 to 0.7. Since γ has a value of 0.3 when the stereo image has little texture and D_{%}=0, C=0.7C_{α}+0.3C_{β} is obtained. Accordingly, a new value obtained by multiplying 0.7 by the normalized cross correlation coefficient and by multiplying 0.3 by the normalized edge correlation coefficient is the pixel value of the composite disparity space image. When edge information is strong and D_{%}=70, γ has a value of 0.58, and thus C=0.42C_{α}+0.58C_{β} is obtained.

The disparity information extraction unit 500 extracts disparity surface information from the composite 3D space image into which the edge disparity space image and the luminance disparity space image are combined by the disparity space image combination unit 400. Depending on circumferences, the disparity information extraction unit 500 may extract disparity surface information using only the edge disparity space image generated by the edge disparity space image generation unit 360, rather than the 3D space image generated by the disparity space image combination unit 400. In this case, the disparity information extraction unit 500 may extract the disparity surface information by searching the composite 3D space image generated by the disparity space image combination unit 400 or the edge disparity space image generated by the edge disparity space image generation unit 360 for a locally optimized solution or a globally optimized solution. Methods by which the disparity information extraction unit 500 searches the composite 3D space image, into which the edge disparity space image and the luminance disparity space image are combined, or the edge disparity space image for a locally optimized solution or a globally optimized solution may be generally implemented using widely known methods.

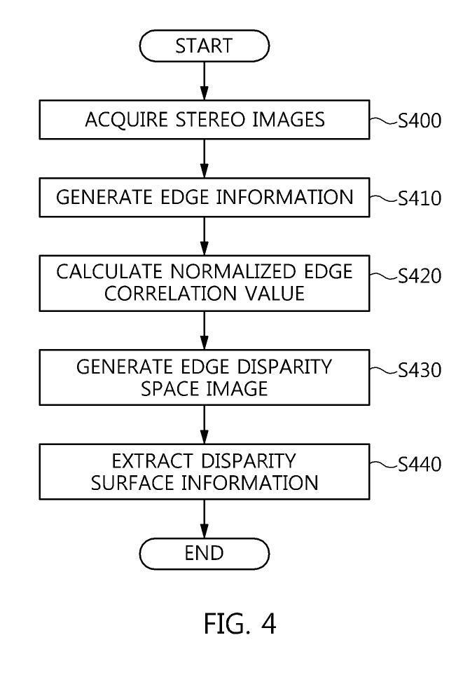

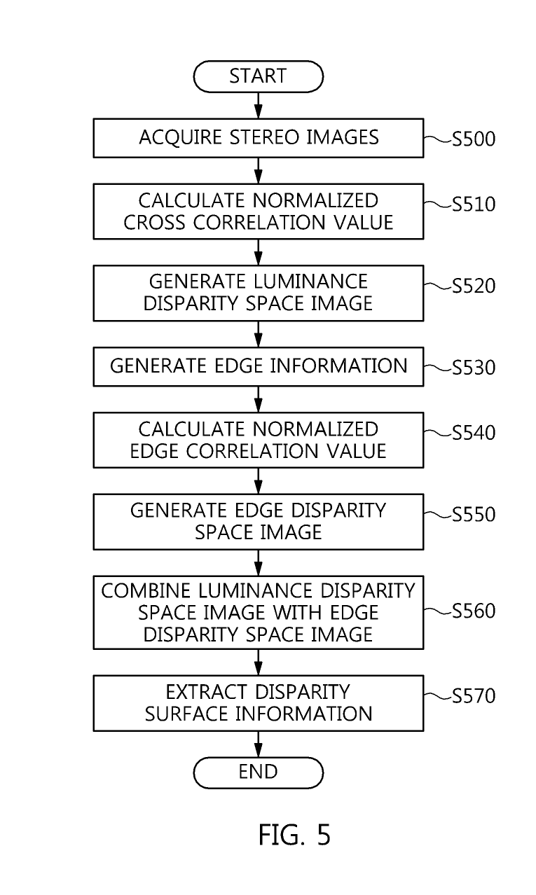

Hereinafter, a method of reconstructing 3D information according to the present invention will be described with reference to FIGS. 4 and 5. A description of some parts overlapping the operation of the 3D information reconstruction apparatus according to the present invention, as described above with reference to FIGS. 1 to 3, will be omitted.

FIG. 4 is a flowchart showing a method of reconstructing 3D information according to an embodiment of the present invention.

Referring to FIG. 4, in the 3D information reconstruction method according to the embodiment of the present invention, the stereo image acquisition unit 100 acquires two or more stereo images having a parallax therebetween from an object at step S400.

Next, the edge information generation unit 320 generates edge information, which is feature information, for each of the stereo images acquired at step S400 by using an edge operator at step S410. In this case, the edge information generation unit 320 may generate the edge information by calculating edge vectors for corresponding pixels in the stereo images.

Next, the normalized edge correlation calculation unit 340 calculates a normalized edge correlation coefficient for the corresponding pixels in the stereo images using the edge information, generated for each of the stereo images at step S410, at step S420. In this case, the normalized edge correlation calculation unit 340 may calculate the normalized edge correlation coefficient using geometric characteristics between edge vectors calculated for the corresponding pixels in the stereo images, for example, an angle between the edge vectors.

Further, the edge disparity space image generation unit 360 generates a 3D edge disparity space image based on the normalized edge correlation coefficient, calculated for the corresponding pixels in the stereo images at step S420, at step S430.

Finally, the disparity information extraction unit 500 extracts disparity surface information from the edge disparity space image generated at step S430, at step S440.

FIG. 5 is a flowchart showing a method of reconstructing 3D information according to another embodiment of the present invention.

Referring to FIG. 5, in the 3D information reconstruction method according to another embodiment of the present invention, the stereo image acquisition unit 100 acquires two or more stereo images having a parallax therebetween from an object at step S500.

Then, the normalized cross correlation calculation unit 220 calculates a normalized cross correlation coefficient for corresponding pixels in the stereo images using the luminance information of a center pixel and neighboring pixels around the center pixel in each of the stereo images, obtained at step S500, at step S510.

Next, the luminance disparity space image generation unit 240 generates a 3D luminance disparity space image based on the normalized cross correlation coefficient, calculated for the corresponding pixels in the stereo images at step S510, at step S520.

Meanwhile, the edge information generation unit 320 generates edge information, which is feature information, for each of the stereo images acquired at step S500, by using an edge operator at step S530. In this case, the edge information generation unit 320 may calculate edge vectors for the corresponding pixels in the stereo images and then generate the edge information.

Next, the normalized edge correlation calculation unit 340 calculates a normalized edge correlation coefficient for the corresponding pixels in the stereo images using the edge information generated for each of the stereo images at step S530, at step S540. In this case, the normalized edge correlation calculation unit 340 may calculate the normalized edge correlation coefficient using geometric characteristics between the edge vectors calculated for the corresponding pixels in the stereo images, for example, an angle between the edge vectors.

Further, the edge disparity space image generation unit 360 generates a 3D edge disparity space image based on the normalized edge correlation coefficient, calculated for the corresponding pixels in the stereo images at step S530, at step S550.

Although a configuration in which steps S530 to S550 are performed after steps S510 and S520 have been performed has been illustrated in FIG. 5, steps S530 to S550 may be performed in parallel with steps S510 and S520.

Thereafter, the disparity space image combination unit 400 combines the luminance disparity space image generated by the luminance disparity space image generation unit 240 at step S520 and the edge disparity space image generated by the edge disparity space image generation unit 360 at step S550 into a single composite 3D space image at step S560.

Finally, the disparity information extraction unit 500 extracts disparity surface information from the composite 3D space image generated by the disparity space image combination unit 400 at step S560, at step S570.

As described above, the present invention uses a method of calculating matching costs using the edge correlation information of stereo images in order to solve a problem in that it is difficult to improve the precision of matching between stereo images because the reliability of disparity information included in a disparity space configured for matching between the stereo images is low. Normalized Edge Correlation (NEC) is advantageous in that both the sizes of a window for obtaining an edge and a window for aggregating matching costs can be adjusted. Accordingly, NEC is advantageous in that the influence of a blurring effect, occurring as the size of the window for aggregating matching costs increases during a procedure for using typical normalized cross correlation coefficients, can be reduced. NEC is advantageous in that edge information previously includes the influence of the luminance distributions of neighboring pixels, and thus highly reliable matching results are provided compared to Normalized Cross Correlation (NCC) that is typically used. Furthermore, since the edge normalized correlation coefficient has geometric characteristics similar to those of a normalized cross correlation coefficient that is typically used, there is an advantage in that disparity surface information can be extracted by obtaining two coefficients and combining the two disparity space images into a single disparity space image.

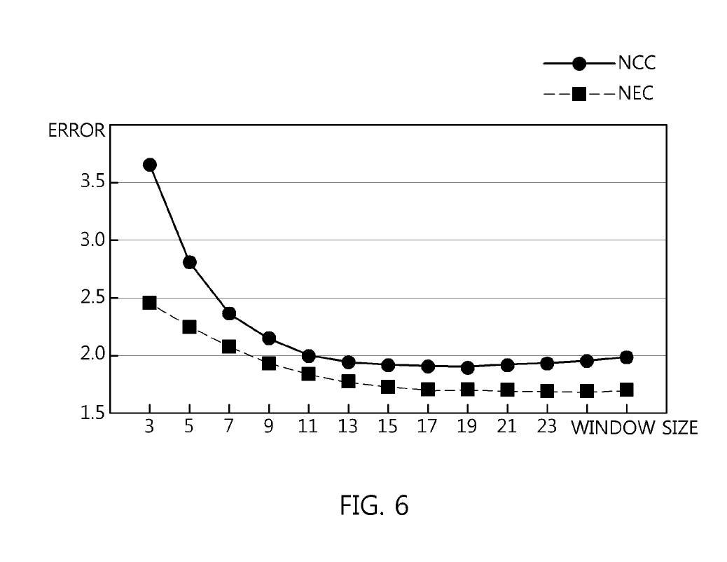

FIG. 6 is a graph illustrating a matching error between Normalized Cross Correlation (NCC) and Normalized Edge Correlation (NEC). In FIG. 6, ‘NCC’ denotes the results of the NCC, and ‘NEC’ denotes the results of the NEC using a 7×7 Sobel kernel. Further, a vertical axis denotes a matching error and a horizontal axis denotes the size of a window for aggregating matching costs. As seen in FIG. 6, results indicating that NEC exhibits less error than NCC regardless of the size of the window can be derived.

In accordance with the present invention, there is an advantage in that technology can be provided which can reconstruct precise 3D information from a 3D space image by utilizing a local matching scheme based on edge information, designed to have the same characteristics as a local matching scheme based on luminance information.

Further, in accordance with the present invention, there is an advantage in that, compared to a scheme that is typically used based on a normalized cross correlation coefficient, highly reliable matching results can be provided by utilizing a method of calculating matching costs based on a normalized edge correlation coefficient calculated from edge information that previously includes the influence of the luminance distributions of neighboring pixels in each stereo image.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for reconstructing three-dimensional (3D) information, comprising:
a stereo image acquisition unit configured to acquire stereo images having a parallax therebetween from an object;
an edge information generation unit configured to generate edge information that is feature information about each of the stereo images, using an edge operator;
a normalized edge correlation calculation unit configured to calculate a normalized edge correlation coefficient for corresponding pixels in the stereo images by using the edge information;
an edge disparity space image generation unit configured to generate a 3D edge disparity space image based on the normalized edge correlation coefficient; and
a disparity information extraction unit configured to extract disparity surface information using the edge disparity space image.

2. The apparatus of claim 1, wherein the edge information generation unit calculates edge vectors for the corresponding pixels in the stereo images, and then generates the edge information.

3. The apparatus of claim 2, wherein the normalized edge correlation calculation unit calculates the normalized edge correlation coefficient using geometric characteristics between the edge vectors calculated for the corresponding pixels in the stereo images.

4. The apparatus of claim 3, wherein the geometric characteristics between the edge vectors include an angle between the edge vectors.

5. The apparatus of claim 4, further comprising a normalized cross correlation calculation unit configured to calculate a normalized cross correlation coefficient for the corresponding pixels in the stereo images using luminance information of a center pixel and neighboring pixels around the center pixel in each of the stereo images.

6. The apparatus of claim 5, further comprising a luminance disparity space image generation unit configured to generate a 3D luminance disparity space image based on the normalized cross correlation coefficient.

7. The apparatus of claim 6, further comprising a disparity space image combination unit configured to combine the edge disparity space image generated by the edge disparity space image generation unit and the luminance disparity space image generated by the luminance disparity space image generation unit into a single composite 3D space image.

8. The apparatus of claim 7, wherein the disparity information extraction unit extracts the disparity surface information from the composite 3D space image into which the edge disparity space image and the luminance disparity space image are combined.

9. A method of reconstructing three-dimensional (3D) information, comprising:
acquiring, by a stereo image acquisition unit, stereo images having a parallax therebetween from an object;
generating, by an edge information generation unit, edge information that is feature information about each of the stereo images, using an edge operator;
calculating, by a normalized edge correlation calculation unit, a normalized edge correlation coefficient for corresponding pixels in the stereo images by using the edge information;
generating, by an edge disparity space image generation unit, a 3D edge disparity space image based on the normalized edge correlation coefficient; and
extracting, by a disparity information extraction unit, disparity surface information from the edge disparity space image.

10. The method of claim 9, wherein generating the edge information that is the feature information about each of the stereo images comprises calculating edge vectors for the corresponding pixels in the stereo images and then generating the edge information.

11. The method of claim 10, wherein calculating the normalized edge correlation coefficient for the corresponding pixels in the stereo images comprises calculating the normalized edge correlation coefficient using geometric characteristics between the edge vectors calculated for the corresponding pixels in the stereo images.

12. The method of claim 11, wherein the geometric characteristics between the edge vectors include an angle between the edge vectors.

13. A method of reconstructing three-dimensional (3D) information, comprising:
acquiring, by a stereo image acquisition unit, stereo images having a parallax therebetween from an object;
calculating, by a normalized cross correlation calculation unit, a normalized cross correlation coefficient for the corresponding pixels in the stereo images using luminance information of a center pixel and neighboring pixels around the center pixel in each of the stereo images;
generating, by a luminance disparity space image generation unit, a 3D luminance disparity space image based on the normalized cross correlation coefficient calculated for the corresponding pixels in the stereo images;
generating, by an edge information generation unit, edge information that is feature information about each of the stereo images, using an edge operator;
calculating, by a normalized edge correlation calculation unit, a normalized edge correlation coefficient for the corresponding pixels in the stereo images by using the edge information generated for each of the stereo images;
generating, by an edge disparity space image generation unit, a 3D edge disparity space image based on the normalized edge correlation coefficient calculated for the corresponding pixels in the stereo images;
combining, by a disparity space image combination unit, the luminance disparity space image generated by the luminance disparity space image generation unit and the edge disparity space image generated by the edge disparity space image generation unit into a single composite 3D space image; and
extracting disparity surface information from the composite 3D space image into which the edge disparity space image and the luminance disparity space image are combined.

14. The method of claim 13, wherein generating the edge information that is the feature information about each of the stereo images comprises calculating edge vectors for the corresponding pixels in the stereo images and then generating the edge information.

15. The method of claim 14, wherein calculating the normalized edge correlation coefficient for the corresponding pixels in the stereo images comprises calculating the normalized edge correlation coefficient using geometric characteristics between the edge vectors calculated for the corresponding pixels in the stereo images.

16. The method of claim 15, wherein the geometric characteristics between the edge vectors calculated for the corresponding pixels in the stereo images include an angle between the edge vectors calculated for the corresponding pixels in the stereo images.
